(19) United States
(12) Patent Application Publication
(10) Pub. No.: US 2017/0351353 A1
(43) Pub. Date: Dec. 7, 2017

(54) OPERATION DEVICE

(71) Applicant: KABUSHIKI KAISHA TOKAI RIKA DENKI SEISAKUSHO, Aichi (JP)

(72) Inventor: Shuichi TAKEUCHI, Aichi (JP)

(21) Appl. No.: 15/609,859

(22) Filed: May 31, 2017

(30) Foreign Application Priority Data
Jun. 3, 2016 (JP) 2016-111666

(51) Int. Cl. G06F 3/043; G06F 3/0354

(52) U.S. Cl. CPC G06F 3/043; G06F 3/03547

(57) ABSTRACT

An operation device includes an operation unit including an operation surface on which an operator performs a press operation, an ultrasonic drive unit configured to ultrasonically drive the operation surface, a load detection unit configured to detect a pressing load for the press operation, and a controller configured to control ultrasonic driving of the ultrasonic drive unit, the controller being configured to, when the pressing load is equal to or greater than a predetermined load, ultrasonically drive the operation surface at an ultrasonic driving force equal to or greater than a predetermined ultrasonic driving force so as to provide a thermal presentation to the operator to indicate that the press operation is initiated.

The present application is based on Japanese patent application No. 2016-111666 filed on Jun. 3, 2016, the entire contents of which are incorporated herein by reference.

### BACKGROUND OF THE INVENTION

### Technical Field

The present invention relates to operation devices, and in particular, to an operation device that provides a stimulus presentation by heat.

### Background Art

There are known conventional input devices configured as follows. The input devices are of compact and simple configuration and have press-type input units. When the input units are manipulated, the devices are able to present, to the operator, a sensation of pushing down similar to the sensation of pushing down a push button switch (see Patent Literature 1, for example).

The operation device of Patent Literature 1 includes an input unit for accepting a press input, a load detection unit for detecting a pressing load to the input unit, a vibration unit for vibrating the input unit, and a control unit for controlling driving of the vibration unit when the pressing load detected by the load detection unit satisfies a predetermined criterion for accepting an input to the input unit, so as to generate a floating force on a pressing object pressing the input unit.

The input unit of the operation device is a plate-shaped operation surface. When the load applied to the operation surface reaches a predetermined value, the operation surface is vibrated to produce a squeeze film effect, which acts on the finger, and to thereby cause a floating force on the finger. When the frictional resistance (frictional force) between the operation surface and the finger is reduced and the fingertip is slightly slid, an illusion is created for the operator that the load is abruptly decreased. In this manner, the load characteristics of a pushing-down operation are represented, and thus the sensation of pushing down similar to the sensation of pushing down a push button switch is presented to the operator.

### CITATION LIST

### Patent Literature

Patent Literature 1: Japanese Unexamined Patent Application Publication No. 2010-140102A

### SUMMARY OF THE INVENTION

### Technical Problem

However, the conventional operation device of Patent Literature 1 utilizes the frictional force, and therefore requires that the finger performing the operation move in the shearing direction with respect to the operation surface. In addition, the presentation of a sensation of pushing down via the squeeze film effect using ultrasonic vibration as a feedback means poses the following problem. The squeeze film effect is effective until the finger touches the operation surface, but when the finger is in contact with the operation surface, the effect diminishes so that the presentation of a sensation of pushing down is not accomplished.

Accordingly, an object of the present invention is to provide an operation device that effectively provides a stimulus presentation by heat to the operator in response to a press operation on the operation surface.

### Solution to Problem

[1] In order to achieve the above object, the present invention provides an operation device including an operation unit, an ultrasonic drive unit, a load detection unit, and a controller. The operation unit includes an operation surface on which an operator performs a press operation. The ultrasonic drive unit is configured to ultrasonically drive the operation surface. The load detection unit is configured to detect a pressing load for the press operation. The controller is configured to control ultrasonic driving of the ultrasonic drive unit, and the controller is configured to, when the pressing load is equal to or greater than a predetermined load, ultrasonically drive the operation surface at an ultrasonic driving force equal to or greater than a predetermined ultrasonic driving force so as to provide a thermal presentation to the operator to indicate that the press operation is initiated.
[2] The operation device according to [1] may be such that the thermal presentation takes place for a predetermined period of time after the pressing load reaches a load equal to or greater than the predetermined load.
[3] The operation device according to [1] or [2] may be such that, when the press operation is initiated on the operation surface at a load equal to or greater than the predetermined load, the controller determines that an ON operation is initiated on the operation unit by the press operation.

### Advantageous Effects of Invention

[4] The operation device according to any one of [1] to [3], wherein the controller determines whether or not the pressing load is equal to or greater than a predetermined load only when a finger of the operator falls within a predetermined region of the operation surface, and wherein the controller does not provide the thermal presentation to the operator when the finger of the operator does not fall within the predetermined region of the operation surface.
[5] The operation device according to any one of [1] to [4], wherein the controller provide an operational feeling by a squeeze film effect to the operator by ultrasonically driving the operation surface at an ultrasonic driving force less than the predetermined ultrasonic driving force when a finger of the operator does not fall within a predetermined region of the operation surface.

The present invention provides an operation device that effectively provides a stimulus presentation by heat to the operator in response to a press operation on the operation surface.

### BRIEF DESCRIPTION OF THE DRAWINGS

FIG. 1A is a top view of an operation device according to a first embodiment of the present invention.

FIG. 1B is a front view of the operation device illustrated in FIG. 1A.

FIG. 2 is a block diagram illustrating a configuration of the operation device according to the first embodiment of the present invention.

FIG. 3 is an operation state diagram illustrating an operation being performed by a finger on the operation surface of the touch pad in the operation device according to the first embodiment of the present invention.

FIG. 4 is a graph illustrating a press operation and a thermal presentation in an exemplary operation of the first embodiment, wherein (a) is a graph showing the relationship between a load signal Vg and time t and (b) is a graph showing the relationship between the ultrasonic driving force (amplitude) and time t.

FIG. 5 is a flowchart illustrating the performance of the operation device according to the first embodiment.

FIG. 6A is an operation state diagram illustrating a tracing operation being performed by a finger on an operation surface of a touch pad in an operation device according to a second embodiment of the present invention.

FIG. 6B is an operation state diagram illustrating a press operation being performed by the finger on the operation surface of the touch pad in the operation device.

FIG. 7 is a graph illustrating a press operation, a squeeze effect, and a thermal presentation in an exemplary operation of the second embodiment, wherein (a) is a graph showing the relationship between a load signal Vg and time t and (b) is a graph showing the relationship between the ultrasonic driving force (amplitude) and time t.

FIG. 8 is a flowchart illustrating the performance of the operation device according to the second embodiment.

### DETAILED DESCRIPTION OF THE PREFERRED EMBODIMENTS

### First Embodiment

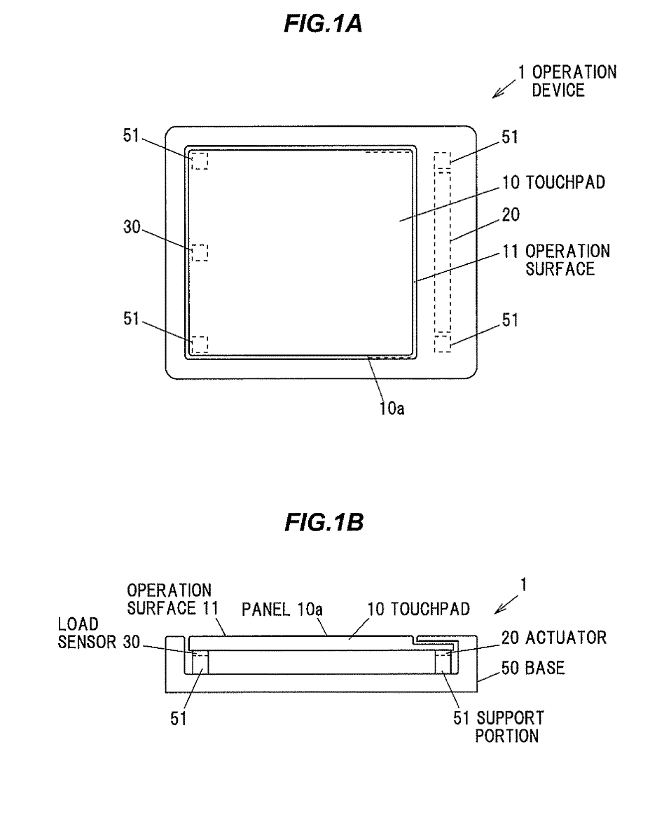

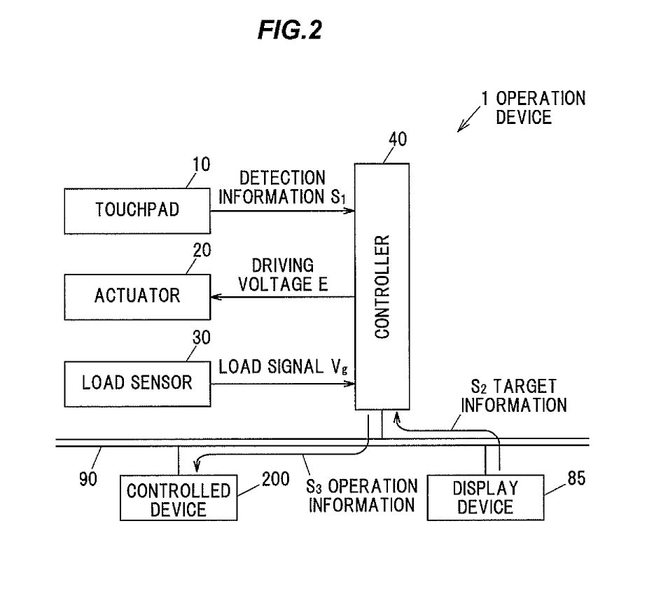

FIG. 1A is a top view of an operation device according to a first embodiment of the present invention, and FIG. 1B is a front view of the operation device illustrated in FIG. 1A. FIG. 2 is a block diagram illustrating a configuration of the operation device according to the first embodiment of the present invention.

An operation device 1 according to the first embodiment of the present invention includes a touch pad 10, an actuator 20, a load sensor 30, and a controller 40. The touch pad 10 is an operation unit having an operation surface 11 on which an operator performs press operations. The actuator 20 is an ultrasonic drive unit for ultrasonically driving the operation surface 11. The load sensor 30 is a load detection unit for detecting the pressing load for the press operation. The controller 40 controls the ultrasonic driving of the ultrasonic drive unit. The controller 40 is configured to, when the pressing load is equal to or greater than a predetermined load, ultrasonically drive the operation surface 11 at an ultrasonic driving force equal to or greater than a predetermined ultrasonic driving force so as to provide a thermal presentation to the operator to indicate that the press operation is initiated.

### Touch Pad 10

The touch pad 10 is, for example, a touch sensor for detecting the position touched by an operating finger on the operation surface 11. The operator can, for example, remotely operate an electronic device coupled to the operation device by manipulating the operation surface 11. Examples of the touch pad 10 include resistive touch pads, infrared touch pads, Surface Acoustic Wave (SAW) touch pads, capacitive touch pads, and detection devices that detect the contact location by capturing images of the operation surface 11. In this embodiment, the touch pad 10 is a capacitive touch pad, for example.

As illustrated in FIGS. 1A and 1B, the touch pad 10 includes, for example, a panel 10a. The front side of the panel 10a is the operation surface 11. A plurality of driving electrodes and detection electrodes (not illustrated), intersecting each other and being insulated from each other, are disposed on the panel 10a. By scanning the plurality of driving electrodes and detection electrodes, the touch pad 10 detects the capacitance determined by the combination of the driving electrodes and the detection electrodes. For example, by comparing the capacitance with a predetermined threshold value, the touch pad 10 calculates the coordinates of the detection points where the operating finger has been detected for one cycle, and periodically outputs the result, which is denoted as detection information S₁, to the controller 14. The coordinates are, for example, coordinates in a rectangular coordinate system set for the operation surface 11.

As illustrated in FIGS. 1A and 1B, the panel 10a of the touch pad 10 is supported on support portions 51 at both ends or at the perimeter. The support portions are provided on a base 50. The panel 10a is capable of vibrating in a panel thickness direction in a predetermined vibration mode. This vibration is excited by an actuator 20, which is attached to the lower surface of the panel 10a. The operation surface 11 is constituted by the front side of the panel 10a excluding the portion on the actuator 20.

### Actuator 20

The actuator 20 may include an ultrasonic transducer that serves as the ultrasonic drive unit for ultrasonically driving the operation surface 11. The ultrasonic transducer is, for example, a multi-layer piezoelectric element serving as a piezoelectric vibrator. The multi-layer piezoelectric element expands and contracts by means of applied voltage, for example. In this embodiment, as illustrated in FIGS. 1A and 1B, the rectangular actuator 20 is mounted, for example, along an edge of the panel 10a, which is a constituent of the touch pad 10. Expansion and contraction of the actuator 20 generates vibration.

Examples of the material of the piezoelectric element include lithium niobate, barium titanate, lead titanate, lead zirconate titanate (PZT), lead metaniobate, polyvinylidene fluoride (PVDF), polylactic acid, and the like.

Examples of the structure of the piezoelectric element include single-layer bimorph type of structures, single-layer unimorph type of structures, multi-layer unimorph type of structures, and multi-layer bimorph type of structures. The single-layer bimorph type includes a metal plate and films formed on both sides of the metal plate. The films are made of any of the above materials. The single-layer unimorph type includes a metal plate and a film formed on one of the two sides of the metal plate. The film is made of any of the above materials. The multi-layer unimorph type includes a metal plate and films layered on one of the two sides of the metal plate. The films are made of any of the above materials. The multi-layer unimorph type includes a metal plate and films layered on both sides of the metal plate. The films are made of any of the above materials.

The actuator 20 ultrasonically vibrates based on, for example, a sinusoidal driving voltage E, which is output from the controller 40. The frequency of the ultrasonic vibrations is 20 kHz or greater, for example.

When the panel 10a is excited to vibrate by the actuator 20 described above, ultrasonic vibrations occur in the front side of the panel 10a, i.e., the operation surface 11. For example, when a touch operation or a tracing operation is performed with a finger on the operation surface 11, a squeeze film, which is a film of air, forms between the operation surface 11 and the finger, so that a squeeze effect is produced. The squeeze effect refers to a phenomenon in which the film of air between the operation surface 11 and the finger decreases the frictional force for a tracing operation being performed on the operation surface 11. The decrease in the frictional force can be controlled by the excitation force of the actuator 20, i.e., the driving voltage E to be applied to the actuator 20.

On the other hand, when the operator performs a press operation with a fingertip on the front side of the panel 10a, i.e., on the operation surface 11, in which ultrasonic vibration has occurred, the fingertip of the operator is heated and feels the heat. The ultrasonic wave propagates to subcutaneous regions and deep subcutaneous regions, at a very short wavelength relative to the size of a human body, and the wave energy concentrates in the regions. This phenomenon is unique to ultrasonic waves, and electromagnetic waves such as laser light, microwave, and radiowave do not exhibit this characteristic. This heating action can be accomplished in a very short time compared with the time that would be necessary to heat a fingertip by causing an ordinary heating element to generate heat.

When the operator applies a load equal to or greater than a predetermined load to the operation surface 11 by a finger to initiate a press operation, a determination is made that an ON operation is initiated and the actuator 20 excites the panel 10a to vibrate. When this vibration is an ultrasonic vibration of 20 kHz or greater and is due to an ultrasonic driving force sufficient for the above-described heating action to a human body to be effected, the fingertip of the operator is heated and feels the heat, and thus a thermal presentation is achieved. That is, in response to a press operation on the operation surface, a stimulus presentation is effectively provided to the operator to provide a thermal presentation indicating that the press operation on the operation surface by the operator has been initiated. Thus, for example, initiation of an ON operation by a press operation on the touch pad 10 can be indicated.

### Load Sensor 30

The load sensor serves as the load detection unit for detecting the pressing load for a press operation. The load sensor may be of any type, provided that it is capable of detecting operation load caused by a touch operation on the panel surface, and an example thereof is a strain gauge. A strain gauge is a gauge that has a structure in which a metal resistor (metal foil) laid out in a zig-zag shape is attached on a thin insulator, and detects amounts of strain by measuring changes in electrical resistance caused by deformation. This strain gauge is capable of easily detecting micro-strain. Therefore, stress on the panel surface can be calculated from the amount of strain detected, and the operation load can be calculated from the stress. Note that, in this case, relationships between amounts of strain and operation loads are found in advance through calibration or the like.

As illustrated in FIGS. 1A and 1B, the load sensor 30 is attached to a portion of the touch pad 10. In FIG. 1A, the load sensor 30 is mounted to the left edge, for example. The location where the acceleration sensor 20 is attached can be determined on the basis of design restrictions and the like.

In place of the load sensor, an acceleration sensor may be used. An acceleration sensor is an inertial sensor for measuring acceleration. Acceleration measurement and appropriate signal processing allow various information to be generated such as tilt, movement, vibration, and impact. While there are many types of acceleration sensors, here, a micro electro mechanical system (MEMS) acceleration sensor in which MEMS technology is applied can be used. The MEMS acceleration sensor includes a detection element portion for detecting acceleration and a signal processing circuit for amplifying and adjusting a signal from the detection element and outputting the resulting signal. For example, an electrostatic capacitance detection type acceleration sensor is a sensor that detects changes in electrostatic capacitance between a moving part and a fixed part of a sensor element.

### Controller 40

As illustrated in FIG. 2, the controller 40 is coupled to the touch pad 10, the actuator 20, and the load sensor 30, and is coupled to an in-vehicle device 200, for example, via an in-vehicle local area network (LAN) 90 such as a local interconnect network (LIN) and a control area network (CAN). The in-vehicle device 200 is remotely controlled based on operation information S₃ via manipulation of the touch pad 10.

The controller 40 is, for example, a microcomputer including a central processing unit (CPU) that carries out computations, processes, and the like on acquired data in accordance with a stored program, a random access memory (RAM) and a read only memory (ROM) that are semiconductor memories, and the like. A program for operations of the controller 40 and the like, for example, are stored in the ROM. The RAM is used as a storage region that temporarily stores computation results and the like, for example. The controller 40 also includes an internal means for generating a clock signal, and operates on the basis of this clock signal. Furthermore, the controller 40 includes a reference signal generator for generating an ultrasonic vibration of approximately 20 kHz to 40 kHz, for example.

Detection information S₁ is input to the controller 40 from the touch pad 10. The controller 40 is coupled to a display device 85, and the detection information S₁ from the touch pad 10 is position information corresponding to target information S₂ on the display device 85. Thus, the operator can perform, for example, tracing operations and press operations on the touch pad 10 while looking at, for example, menu icons corresponding to the target information S₂ on the display device 85.

The controller 40 outputs the driving voltage E to the actuator 20 in response to a load signal Vg from the load sensor 30. The load signal Vg is output according to, for example, a press operation.

### Performance of Operation Device According to First Embodiment

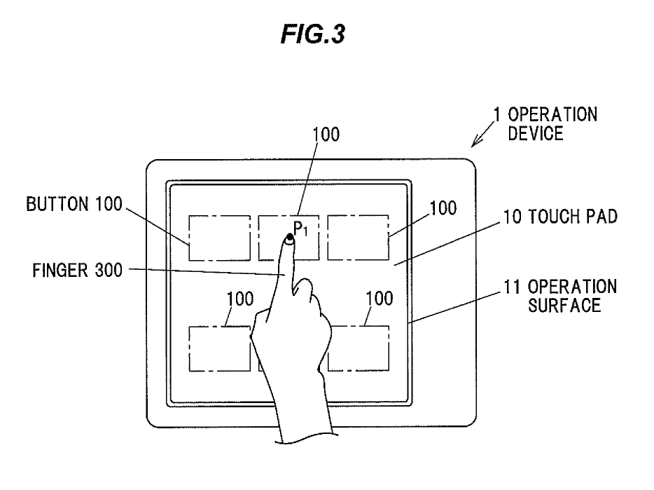

FIG. 3 is an operation state diagram illustrating an operation being performed by a finger on the operation surface of the touch pad in the operation device according to the first embodiment of the present invention. The following description is based on the assumption that the buttons, which are the target of the operation, are displayed as menus on the touch pad 10 as illustrated in FIG. 3.

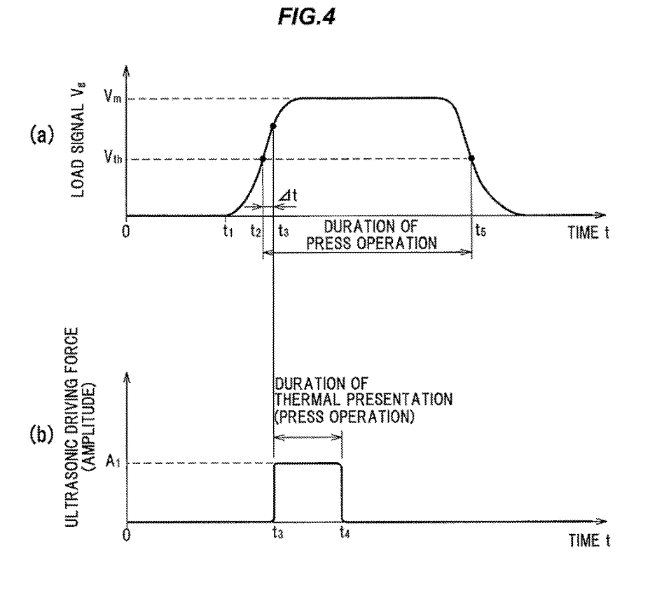

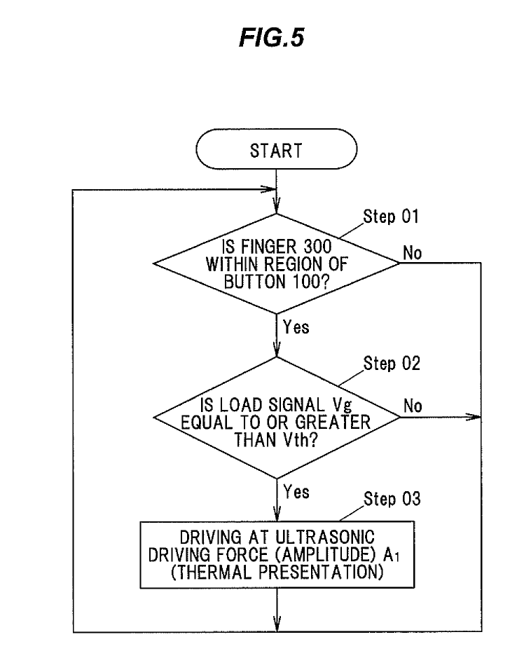

FIG. 4 is a graph illustrating a press operation and a thermal presentation in an exemplary operation of the first embodiment, wherein (a) is a graph showing the relationship between a load signal Vg and time t and (b) is a graph showing the relationship between the ultrasonic driving force (amplitude) and time t. FIG. 5 is a flowchart illustrating the performance of the operation device according to the first embodiment.

Consider a case where a press operation is to be performed on a button 100 by a finger 300 of an operator manipulating the operation surface 11 on the touch pad 10 as illustrated in FIG. 3. In the following, the performance of the operation device according to the first embodiment will be described with reference to FIGS. 3 and 4 and in accordance with the flowchart of FIG. 5.

The controller 40 determines whether the finger 300 of the operator is located within the region of the button 100 based on the detection information S₁ input from the touch pad 10 (Step 01). As illustrated in FIG. 3, when the finger 300 of the operator is detected to be located at a position P₁ and a determination is made that the position P₁ is located within the region of the button 100, the process proceeds to Step 02 (Step 01: Yes), or when a determination is made that the position P1 is not located within the region of the button 100, the process returns to Step 01 to repeat the operation (Step 01: No).

Next, the controller 40 determines, based on the load signal Vg input from the load sensor 30, whether the press operation on the operation surface 11 by the finger 300 of the operator has been initiated (Step 02). As illustrated in FIG. 4 (a), when the finger 300 of the operator attempts a press operation on the operation surface 11, the load signal Vg begins increasing at time t1 and reaches a threshold value Vth at time t2, and increases to, for example, a maximum value Vm.

The controller 40 determines whether the press operation on the operation surface 11 has been initiated by determining, based on the threshold value Vth of the load signal, whether the load signal has exceeded the threshold value Vth. When the load signal Vg is equal to or greater than the threshold value Vth, a determination is made that the press operation has been initiated and the process proceeds to Step 03 (Step 02: Yes), or when the load signal Vg is not equal to or greater than the threshold value Vth, a determination is made that the press operation has not been initiated and the process returns to Step 01 to repeat the operation (Step 02: No).

The controller 40 outputs the driving voltage E to the actuator 20 to ultrasonically drive the operation surface 11 of the touch pad 10 at an ultrasonic driving force (amplitude) A₁ (Step 03). As illustrated in FIG. 4 (a), the ultrasonic driving is carried out only for a predetermined period of time, from the time t2 at which the press operation on the operation surface 11 was initiated to time t3 at which a time period Δt has elapsed from the time t2. This ultrasonic driving is performed to provide a thermal presentation to a degree sufficient for the fingertip of the operator to be heated and feel the heat.

That is, using ultrasonic vibration as a feedback means, presentation of a sensation of pushing down is carried out via a thermal presentation. Heating action using ultrasonic driving can be accomplished for a short period of time. For this reason, the thermal presentation can be limited to the duration from the time t3 to time t4 as illustrated in FIG. 4 (b). The duration of the thermal presentation may be set to a period shorter than the duration of the press operation from the time t3 to time t5 illustrated in FIG. 4 (a). This inhibits excessive heating action to the fingertip of the operator, and as a result, appropriate thermal presentation is achieved.

The controller 40 returns to Step 01 and repeats the operation.

### Effects of the First Embodiment

An operation device 1 according to the first embodiment of the present invention includes the touch pad 10, the actuator 20, the load sensor 30, and the controller 40. The touch pad 10 is an operation unit having the operation surface 11 on which an operator performs press operations. The actuator 20 is an ultrasonic drive unit for ultrasonically driving the operation surface 11. The load sensor 30 is a load detection unit for detecting the pressing load for a press operation. The controller 40 controls the ultrasonic driving of the ultrasonic drive unit. The controller 40 is configured to, when the pressing load is equal to or greater than a predetermined load, ultrasonically drive the operation surface 11 at an ultrasonic driving force equal to or greater than a predetermined ultrasonic driving force so as to provide a thermal presentation to the operator to indicate that the press operation is initiated. This configuration accomplishes presentation of a sensation of pushing down via a thermal presentation using ultrasonic vibration as a feedback means, and thus achieves an operation device that effectively provides a stimulus presentation to the operator in response to a press operation on the operation surface.

### Second Embodiment

The second embodiment is configured to vary the ultrasonic driving force (amplitude) of the actuator 20. By this means, when the finger 300 of the operator is located on a region in the operation surface 11 other than the region of the button 100, a squeeze effect is produced, or when the finger 300 of the operator is located within the region of the button 100 and a press operation is initiated, a thermal presentation is provided. The configurations other than this are the same as those of the first embodiment.

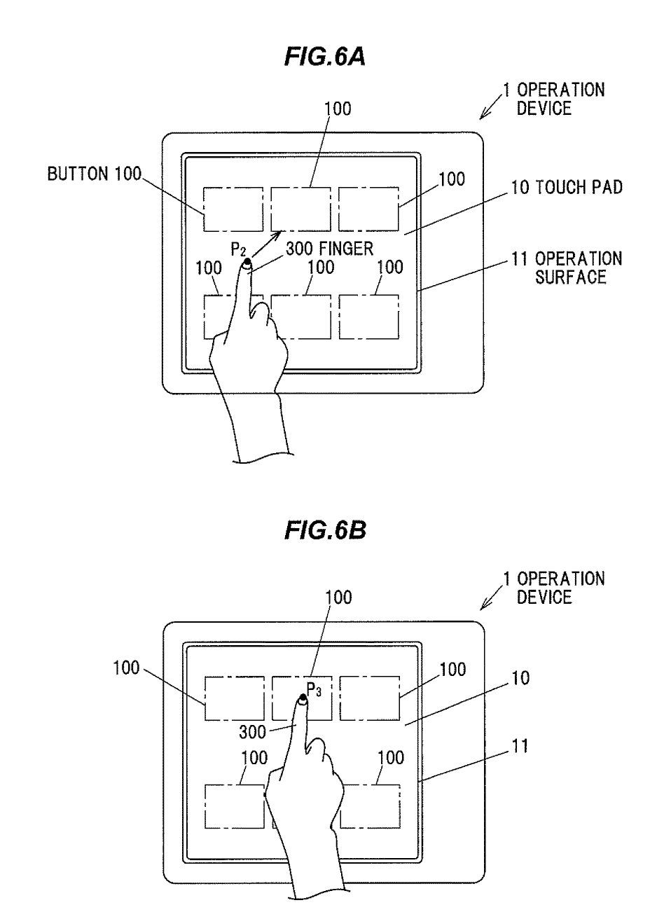

FIG. 6A is an operation state diagram illustrating a tracing operation being performed by a finger on the operation surface of the touch pad in an operation device according to a second embodiment of the present invention, and FIG. 6B is an operation state diagram illustrating a press operation being performed by the finger on the operation surface of the touch pad in the operation device. The following description is based on the assumption that the buttons, which are the target of the operation, are displayed as menus on the touch pad 10 as illustrated in FIGS. 6A and 6B.

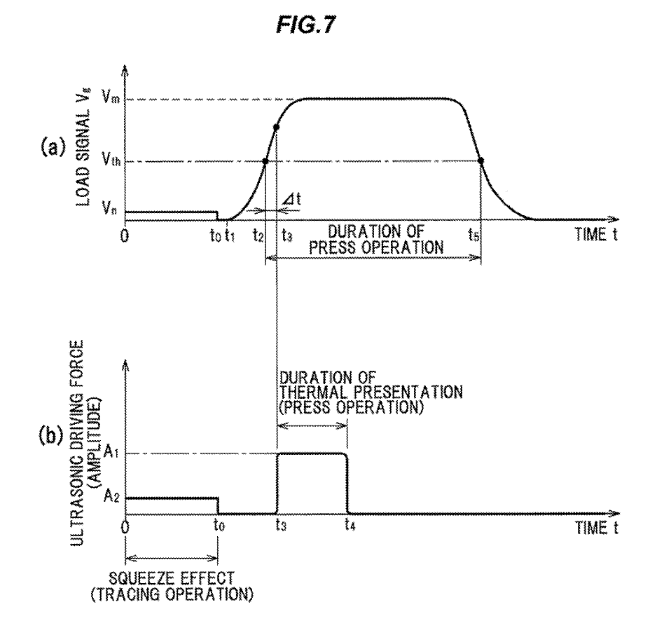

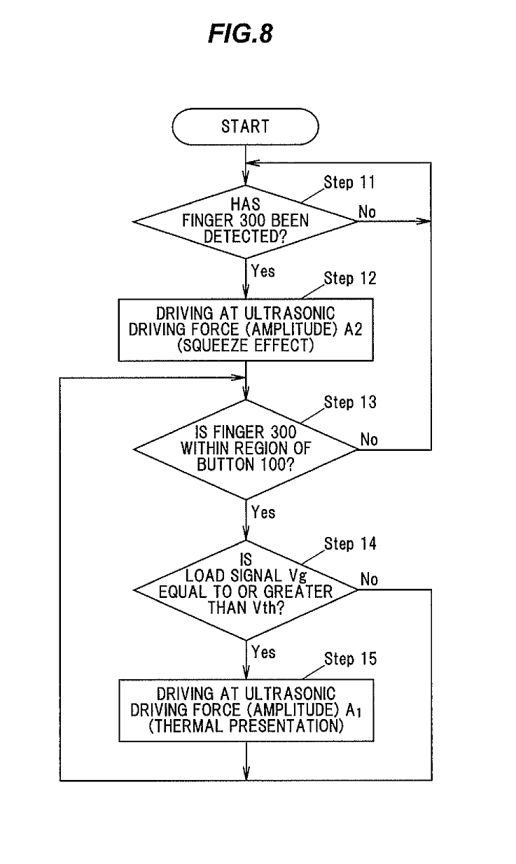

FIG. 7 is a graph illustrating a press operation, a squeeze effect, and a thermal presentation in an exemplary operation of the second embodiment, wherein (a) is a graph showing the relationship between a load signal Vg and time t and (b) is a graph showing the relationship between the ultrasonic driving force (amplitude) and time t. FIG. 8 is a flowchart illustrating the performance of the operation device according to the second embodiment.

Consider a case where, as illustrated in FIG. 6A, a tracing operation is to be performed on the operation surface 11 of the touch pad 10 and, as illustrated in FIG. 6B, a press operation is to be performed within the region of the button 100, by the finger 300 of the operator. In the following, the performance of the operation device according to the second embodiment will be described with reference to FIGS. 6A, 6B, 7, and 8 and in accordance with the flowchart of FIG. 8.

The controller 40 determines whether the finger 300 of the operator is located on the operation surface 11 based on the detection information S₁ input from the touch pad 10 (Step 11). As illustrated in FIG. 6A, when the finger 300 of the operator is detected to be located at a position P₂ and a determination is made that the position P₂ is located on a region in the operation surface 11 other than the region of the button 100, the process proceeds to Step 12 (Step 11: Yes), or when a determination is made that the position P₂ is not located on a region in the operation surface 11 other than the region of the button 100, the process returns to Step 11 to repeat the operation (Step 11: No).

The controller 40 outputs the driving voltage E to the actuator 20 to ultrasonically drive the operation surface 11 of the touch pad 10 at an ultrasonic driving force (amplitude) A₂ (Step 12). As illustrated in FIGS. 6A and 7 (a), the duration of the tracing operation is from 0 to time t0. As illustrated in FIG. 7 (a), during the tracing operation from 0 to time t0, the load signal Vg is less than the threshold value Vth and thus the press operation has not been initiated. During the duration of the tracing operation, the controller 40 ultrasonically drives the operation surface 11 of the touch pad 10 at an ultrasonic driving force (amplitude) A₂. This ultrasonic driving is intended to produce a squeeze effect. This ultrasonic driving is performed at an amplitude smaller than the ultrasonic driving force (amplitude) A₁, which is intended to provide a thermal presentation. This configuration forms an air film between the operation surface 11 and the finger 300, and as a result, the operator feels a squeeze effect by which the frictional force is reduced for a tracing operation on the operation surface 11.

The controller 40 determines whether the finger 300 of the operator is located within the region of the button 100 based on the detection information S₁ input from the touch pad 10 (Step 13). As illustrated in FIG. 6B, when the finger 300 of the operator is detected to be located at a position P₃ and a determination is made that the position P₃ is located within the region of the button 100, the process proceeds to Step 14 (Step 13: Yes), or when a determination is made that the position P₁ is not located within the region of the button 100, the process returns to Step 11 to repeat the operation (Step 13: No).

Next, the controller 40 determines, based on the load signal Vg input from the load sensor 30, whether the press operation on the operation surface 11 by the finger 300 of the operator has been initiated (Step 14). As illustrated in FIG. 7 (a), when the finger 300 of the operator attempts a press operation on the operation surface 11, the load signal Vg begins increasing at the time t1 and reaches the threshold value Vth at the time t2, and increases to, for example, the maximum value Vm.

The controller 40 determines whether the press operation on the operation surface 11 has been initiated by determining, based on the threshold value Vth of the load signal, whether the load signal has exceeded the threshold value Vth. When the load signal Vg is equal to or greater than the threshold value Vth, a determination is made that the press operation has been initiated and the process proceeds to Step 15 (Step 14: Yes), or when the load signal Vg is not equal to or greater than the threshold value Vth, a determination is made that a press operation has not been initiated and the process returns to Step 13 to repeat the operation (Step 14: No).

The controller 40 outputs the driving voltage E to the actuator 20 to ultrasonically drive the operation surface 11 of the touch pad 10 at an ultrasonic driving force (amplitude) A₁ (Step 15). As illustrated in FIG. 7 (a), the ultrasonic driving is carried out only for a predetermined period of time, from the time t2 at which the press operation on the operation surface 11 was initiated to the time t3 at which a time period Δt has elapsed from the time t2. This ultrasonic driving is performed to provide a thermal presentation to a degree sufficient for the fingertip of the operator to be heated and feel the heat.

That is, using ultrasonic vibration as a feedback means, presentation of a sensation of pushing down is carried out via a thermal presentation. Heating action using ultrasonic driving can be accomplished for a short period of time. For this reason, the thermal presentation can be limited to the duration from the time t3 to the time t4 as illustrated in FIG. 7 (b). The duration of the thermal presentation may be set to a period shorter than the duration of the press operation from the time t3 to the time t5 illustrated in FIG. 7 (a). This inhibits excessive heating action to the fingertip of the operator, and as a result, appropriate thermal presentation is achieved.

The controller 40 returns to Step 13 and repeats the operation.

### Effects of the Second Embodiment

The operation device 1 according to the second embodiment produces the following effect in addition to the effects of the first embodiment. The second embodiment is configured to vary the ultrasonic driving force (amplitude) of the actuator 20. By this means, when the finger 300 of the operator is located on a region in the operation surface 11 other than the region of the button 100, a squeeze effect is produced, or when the finger 300 of the operator is located within the region of the button 100 and a press operation is initiated, a thermal presentation is provided. Thus, when a tracing operation is performed on the operation surface 11 of the touch pad 10 and a press operation is performed within the region of the button 100, a squeeze effect and a presentation of a sensation of pushing down via a thermal presentation are achieved by a single actuator.

Although several embodiments of the present invention and a modified example thereof have been described above, these embodiments and modified example are merely examples, and the invention according to claims is not intended to be limited thereto. Furthermore, such novel embodiments and modified examples can be implemented in various other forms, and various omissions, substitutions, changes, and the like can be made without departing from the spirit and scope of the present invention. In addition, all combinations of the features described in these embodiments and modified example are not necessary to solve the problem. Furthermore, these embodiments and modified examples are included within the spirit and scope of the invention and also within the scope of the invention described in the claims and equivalents thereof.

What is claimed is:

1. An operation device, comprising:
an operation unit comprising an operation surface on which an operator performs a press operation;
an ultrasonic drive unit configured to ultrasonically drive the operation surface;
a load detection unit configured to detect a pressing load for the press operation; and
a controller configured to control ultrasonic driving of the ultrasonic drive unit, the controller being configured to, when the pressing load is equal to or greater than a predetermined load, ultrasonically drive the operation surface at an ultrasonic driving force equal to or greater than a predetermined ultrasonic driving force so as to provide a thermal presentation to the operator to indicate that the press operation is initiated.

2. The operation device according to claim 1, wherein the thermal presentation takes place for a predetermined period of time after the pressing load reaches a load equal to or greater than the predetermined load.

3. The operation device according to claim 1, wherein, when the press operation is initiated on the operation surface at a load equal to or greater than the predetermined load, the controller determines that an ON operation is initiated on the operation unit by the press operation.

4. The operation device according to claim 1, wherein the controller determines whether or not the pressing load is equal to or greater than a predetermined load only when a finger of the operator falls within a predetermined region of the operation surface, and
wherein the controller does not provide the thermal presentation to the operator when the finger of the operator does not fall within the predetermined region of the operation surface.

5. The operation device according to claim 1, wherein the controller provides an operational feeling by a squeeze film effect to the operator by ultrasonically driving the operation surface at an ultrasonic driving force less than the predetermined ultrasonic driving force when a finger of the operator does not fall within a predetermined region of the operation surface.
